(19) United States
(12) Patent Application Publication
(10) Pub. No.: US 2017/0093051 A1
(43) Pub. Date: Mar. 30, 2017

(54) WIRE LUG CAPTIVATION SYSTEM AND METHOD

(71) Applicant: Hamilton Sundstrand Corporation, Charlotte, NC (US)

(72) Inventor: Francis C Belisle, Roscoe, IL (US)

(21) Appl. No.: 14/864,970

(22) Filed: Sep. 25, 2015

(51) Int. Cl. H01R 4/34; H01R 43/00

(52) U.S. Cl. CPC H01R 4/34; H01R 43/00

(57) ABSTRACT

A wire lug captivation system includes a bolt having a head, a shank adjacent the head and a threaded portion, the shank having a diameter that is smaller than a diameter of the threaded portion. The system also includes a captivation device including an upper portion, a lower portion and a connecting member that joins the upper and lower portions, the captivation device configured to receive a wire lug between the upper portion and the lower portion and including a threaded hole in the upper portion having diameter that is greater than the diameter of the shank.

### BACKGROUND OF THE INVENTION

The present invention is related to electric connection and, in particular, to facilitate connecting feeder lug to a terminal block.

In many instances a machine, such as a dynamoelectric machine, is contained on a vehicle such as an air craft. A dynamoelectric machine is any type of machine that can generate motion from electricity or vice-versa and includes, for example, motors and generators. Regardless of whether the machine is a motor or a generator, feeder lines are used to transfer electrical power either into or out of the internal portions of the machine. Of course other types of machines on a vehicle such as an aircraft may also be powered by feeder lines.

As illustrated in FIG. 1, a feeder line 10 that is to be connected to a terminal block 12 of a machine via a feeder lug 14. As illustrated, electrical power is transferred between the feeder line 10 and an internal connection 16 a machine 13. The connection path includes the feeder lug 14 which is attached to and secured on a terminal stud 18 by a fastener or nut 20. An optional washer 22 may also be included. The terminal stud 18 is also in electrical communication with a terminal lead 22 that is in electrical communication with the internal connection 16. Of course, other means of transferring electrical power to the internal connection may exist.

To connect the feeder lug 14 to provide power, the feeder lug 14 placed over the stud 18 and then the nut/washer (20, 22) combo is attached. The feeder line 10 may be difficult to arrange requiring that the installer hold it and the lug 14 on the terminal 12 and place the nut/washer (20, 22) combo on with the other hand. In those cases (and others), one or both of the nut 20 and washer 22 may fall or otherwise become unreachable in the installation.

Another approach is to use a terminal block 12 as shown in FIG. 2. In this case, rather than including a stud 18, the block 12 includes a threaded insert 26 into which a bolt 24 is inserted. Like above, such a configuration may be difficult to attach the lug 14 to and one or both of the bolt and washer 22 may be dropped/lost.

### BRIEF DESCRIPTION OF THE INVENTION

According to one embodiment, a wire lug captivation system that includes a bolt having a head, a shank adjacent the head and a threaded portion, the shank having a diameter that is smaller than a diameter of the threaded portion is disclosed. The system also includes a captivation device including an upper portion, a lower portion and a connecting member that joins the upper and lower portions, the captivation device configured to receive a wire lug between the upper portion and the lower portion and including a threaded hole in the upper portion having diameter that is greater than the diameter of the shank.

According to another embodiment, an assembly that includes a bolt having a head, a shank adjacent the head and a threaded portion, the shank having a diameter that is smaller than a diameter of the threaded portion is disclosed. The system also includes a captivation device including an upper portion, a lower portion and a connecting member that joins the upper and lower portions, the upper portion including a threaded hole having a diameter that is greater than the diameter of the shank and a lower hole in the lower portion that is larger than and concentric with the threaded hole and a wire lug including at least partially disposed between the upper portion and the lower portion and including a lug hole aligned with the threaded hole and the lower hole. The bolt passes through the threaded hole, the lower hole and the lug hole such that the shank portion is within the threaded hole.

In another embodiment, a method of connecting a terminal lug to a terminal is disclosed. The method includes: providing a bolt having a head, a shank adjacent the head and a threaded portion, the shank having a diameter that is smaller than a diameter of the threaded portion; providing a captivation device including an upper portion, a lower portion and a connecting member that joins the upper and lower portions, the upper portion including a threaded hole having a diameter that is greater than the diameter of the shank and a lower hole in the lower portion that is larger than and concentric with the threaded hole; disposing a wire lug including at least partially disposed between the upper portion and the lower portion and including a lug hole aligned with the threaded hole and the lower hole; and threading and urging the bolt through the upper portion until the bolt passes through the threaded hole, the lower hole and the lug hole such that the shank portion is within the threaded hole.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a feeder lug coupled to a terminal block with a terminal stud according to the prior art;

FIG. 2 is a perspective view of a feeder lug coupled to a terminal block with a terminal insert according to the prior art;

FIG. 3 is an exploded view of a wire lug captivation system according to one embodiment;

FIG. 4 is a side-view of a bolt that may be used in a wire lug captivation system according to one embodiment;

FIG. 5 is perspective view of a captivation device according to one embodiment; and

FIG. 6 shows an assembled captivation system prior to being connected to a terminal.

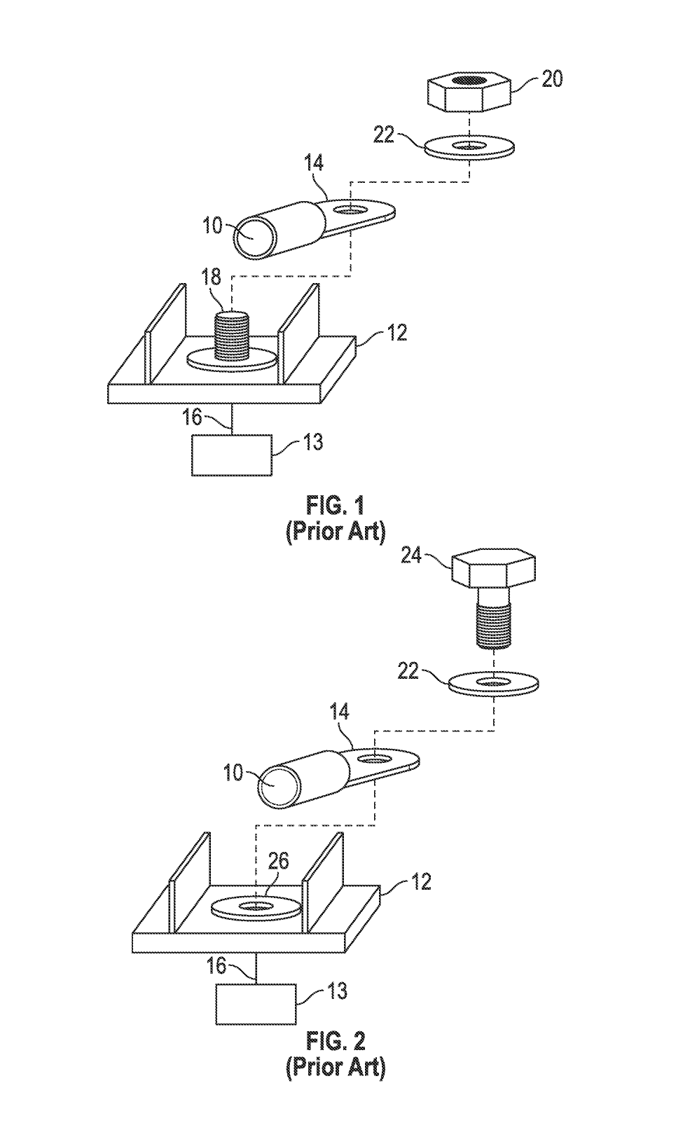

### DETAILED DESCRIPTION OF THE INVENTION

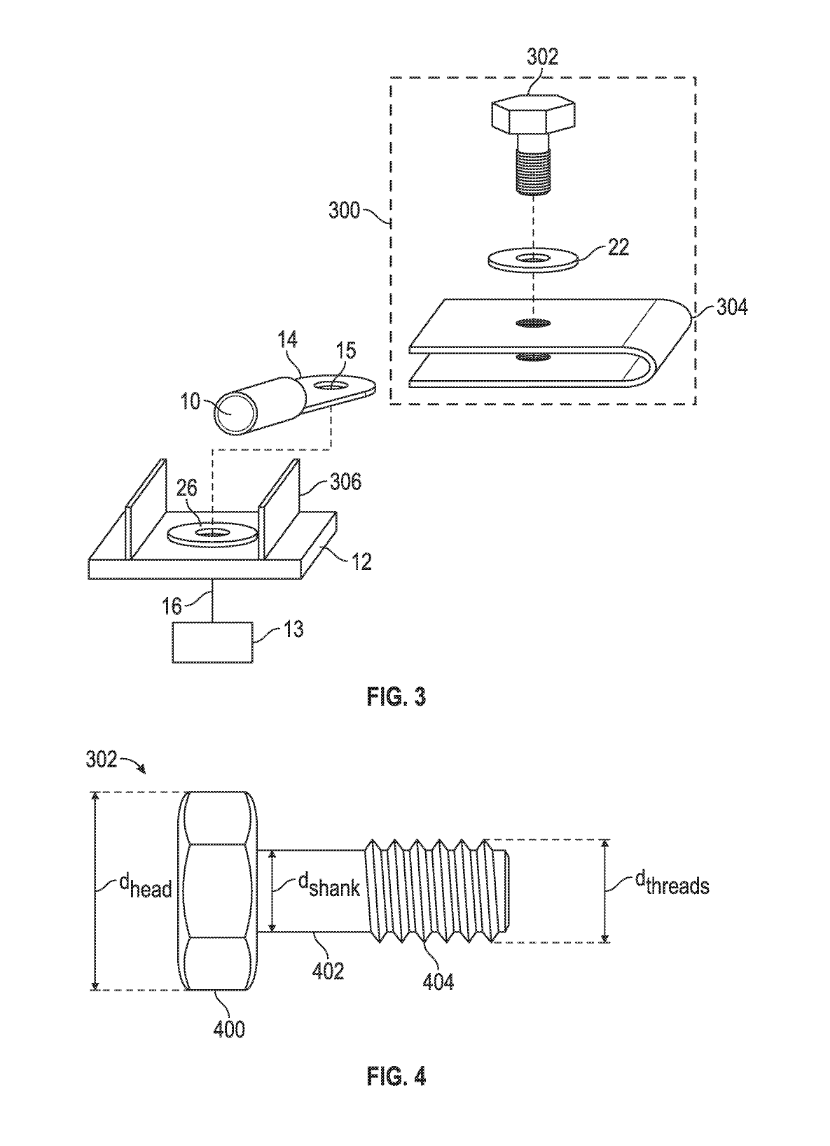

FIG. 3 shows an example of a wire lug captivation system according to one embodiment. The system 300 is to be connected to include a feeder line 10 that is to be connected to a terminal block 12 of a machine via a feeder lug 14. As illustrated, electrical power is transferred between the feeder line 10 and an internal connection 16 a machine 13.

With reference now to FIGS. 3-5, the terminal block 12 in this embodiment includes a threaded insert 26 into which a bolt 302 is inserted. The bolt 302 is, in one embodiment, includes a head 400, a shank 402 and a threaded portion 404. The shank 402 has a diameter, dₛₕₐₙₖ, that is less than the diameter, d_{threads}, of the threads 400. The head 400 could be any shape and may be manipulated (e.g., turned) by any type of device). For example, the head 400 could be a hex-head that that is turned by a socket wrench or it could a slot or phillips-shaped groove such that in can be rotated by a screw driver. The head 400 has a diameter, d_{head}, that is greater than both dₛₕₐₙₖ and d_{threads} in one embodiment. As illustrated, the shank 402 does not include threads.

The system 300 also includes a captivation device 304. The captivation device 304 is sized and arranged such that the lug 14 may be inserted into it and then the bolt 302 passed through both the captivation device 304 and the hole 15 in lug 14 and then screwed into the threads 26 in the insert 12. The bolt 302 may also pass through optional washer 22 before passing through the captivation device 304.

The captivation device 304 may include an upper portion 502 and a lower portion 504. The upper and lower portions 502, 504 are connected by a connection portion 510. As illustrated, the connecting portion 510 is arcuate. While not illustrated it shall be understood that another connecting portion may be included on an opposing side of the upper and lower portions 502, 504 in one embodiment. Further, the particular shape of the connecting member 510 is not limited to arcuate. In one embodiment, and captivation device 304 may be formed by compressing a tubular section of a conductive metal (e.g., copper_pipe.

The upper portion 502 includes a hole 508 formed there through that includes threads 506. An inner diameter of the threads 506 is larger than the diameter of the shank dₛₕₐₙₖ in one embodiment. The lower portion 504 includes a hole 510 that is concentric with hole 508 and has a diameter larger than the diameter of the threads d_{threads}.

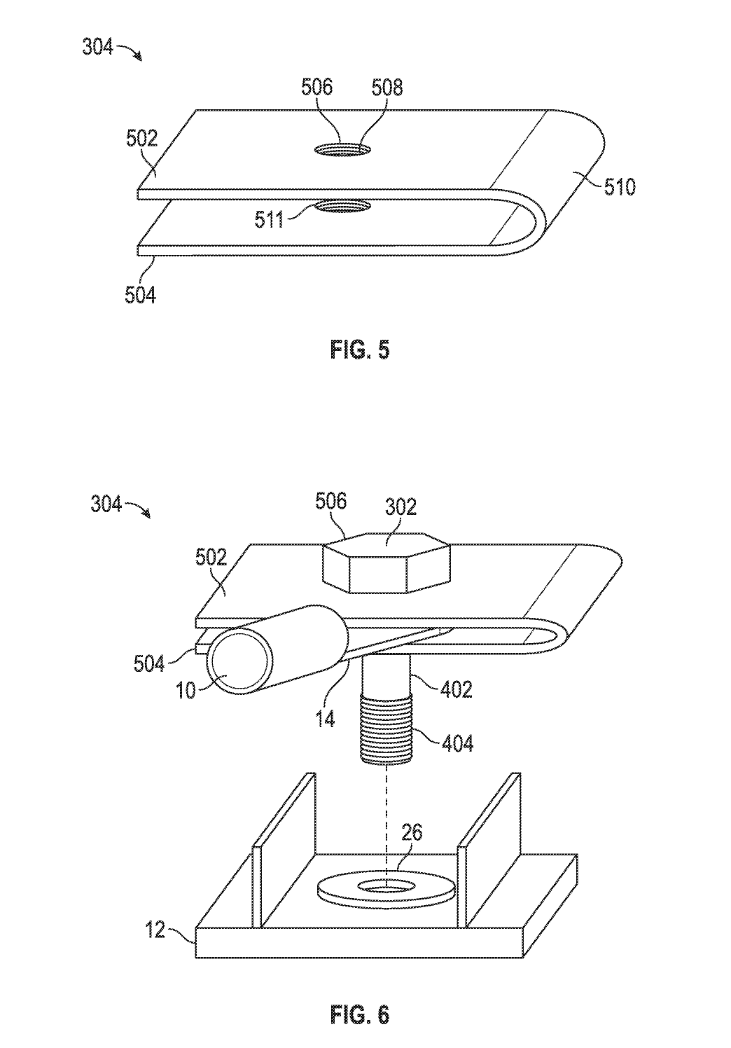

As best seen in FIG. 6, lug 14 may be inserted between the upper and lower portions 502, 504. Then, the bolt 302 be threaded through the threads in the upper portion 502, and passed through the lower portion 504 (and optionally, the washer 22). The shank 402 may extend slightly below the lower portion 502 in one embodiment but in another it may only extent beyond a bottom edge of the threads 506 (FIG. 5) of the upper portion 502. The assembly of the lug 14, bolt, 302 and captivation device 304 will stay together and can then be easily arranged over and screwed into the threads 26 of the terminal 12. Advantageously, such a configuration may lead to reduction is the dropping or loss of the bolt 302 as was experience in some instances as described above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A wire lug captivation system comprising:
a bolt having a head, a shank adjacent the head and a threaded portion, the shank having a diameter that is smaller than a diameter of the threaded portion;
a captivation device including an upper portion, a lower portion and a connecting member that joins the upper and lower portions, the captivation device configured to receive a wire lug between the upper portion and the lower portion and including a threaded hole in the upper portion having diameter that is greater than the diameter of the shank,
wherein the head contacts the upper portion.

2. The system of claim 1, further comprising a washer.

3. The system of claim 1, wherein the threaded hole is sized to mate with the threaded portion of the bolt.

4. The system of claim 1, wherein the lower portion includes a hole having a diameter greater than the threaded portion.

5. The system of claim 4, wherein the hole in the lower portion is concentric with the threaded hole.

6. The system of claim 1, wherein the connecting member is arcuate.

7. The system of claim 1, wherein the captivation device is formed of a conductive metal.

8. An assembly comprising:
a bolt having a head, a shank adjacent the head and a threaded portion, the shank having a diameter that is smaller than a diameter of the threaded portion;
a captivation device including an upper portion, a lower portion and a connecting member that joins the upper and lower portions, the upper portion including a threaded hole having a diameter that is greater than the diameter of the shank and a lower hole in the lower portion that is larger than and concentric with the threaded hole;
a wire lug including at least partially disposed between the upper portion and the lower portion and including a lug hole aligned with the threaded hole and the lower hole;
wherein the bolt passes through the threaded hole, the lower hole and the lug hole such that the shank portion is within the threaded hole and the head contacts the upper portion.

9. (canceled)

10. The assembly of claim 8, wherein threaded hole is sized to mate with the threaded portion of the bolt.

11. The assembly of claim 8, wherein the connecting member is arcuate.

12. The assembly of claim 8, wherein the captivation device is formed of a conductive metal.

13. A method of connecting a terminal lug to a terminal comprising:
providing a bolt having a head, a shank adjacent the head and a threaded portion, the shank having a diameter that is smaller than a diameter of the threaded portion;
providing a captivation device including an upper portion, a lower portion and a connecting member that joins the upper and lower portions, the upper portion including a threaded hole having a diameter that is greater than the diameter of the shank and a lower hole in the lower portion that is larger than and concentric with the threaded hole;
disposing a wire lug including at least partially disposed between the upper portion and the lower portion and including a lug hole aligned with the threaded hole and the lower hole; and
threading and urging the bolt through the upper portion until the bolt passes through the threaded hole, the lower hole and the lug hole such that the shank portion is within the threaded hole and the head contacts the upper portion.
